(19) United States
(12) Patent Application Publication
(10) Pub. No.: US 2011/0315512 A1
(43) Pub. Date: Dec. 29, 2011

(54) PRODUCT COLLATING SYSTEM

(76) Inventor: Fernando M. Serpa, Visalia, CA (US)

(21) Appl. No.: 12/821,379

(22) Filed: Jun. 23, 2010

(51) Int. Cl. B65G 47/57; B65G 47/91

(52) U.S. Cl. 198/471.1

(57) ABSTRACT

A system for collating products may comprise a holding belt mechanism operable to hold onto products introduced vertically onto the holding conveyer belt, a conveyer belt, and a drum mechanism. The drum mechanism may include a rotating outer drum, a plurality of pick head modules on the rotating outer drum, and a plurality of vacuum cups within each of the plurality of pick head modules, wherein the plurality of vacuum cups are operable to capture the products held onto by the holding conveyer belt and to release the products in a collated manner onto the conveyer belt.

### BACKGROUND OF THE INVENTION

The present invention generally relates to a product collating system, and more specifically a machine that rotates, merges, and shingles pouches outputted from a pouch form/fill/seal machine.

### SUMMARY OF THE INVENTION

In one aspect of the present invention, a system for collating a plurality of products may comprise a system for collating a plurality of products comprising a holding belt mechanism operable to hold onto products introduced vertically onto the holding conveyer belt; a conveyer belt; and a drum mechanism including: a rotating outer drum, a plurality of pick head modules on the rotating outer drum, and a plurality of vacuum cups within each of the plurality of pick head modules, wherein the plurality of vacuum cups are operable to capture the products held onto by the holding conveyer belt and to release the products in a collated manner onto the conveyer belt.

In another aspect of the present invention, a method for collating a plurality of products may comprise receiving the plurality of products onto a holding belt mechanism; capturing, by vacuum cups on a rotating outer drum, the plurality of products from the holding conveyer belt; merging and shingling the plurality of products; and releasing from the vacuum cups the merged and shingled plurality of products onto a conveyer belt.

These and other features, aspects and advantages of the present invention will become better understood with reference to the following drawings, description and claims.

### BRIEF DESCRIPTION OF THE DRAWINGS

FIG. 1 shows a perspective view of a product collating system in an operating position in accordance with an embodiment of the present invention;

FIG. 2 shows a side view of the product collating system of FIG. 1;

FIG. 3 shows a side view of the product collating system of FIG. 1 with the drum mechanism in a clear out position in accordance with an embodiment of the present invention;

FIG. 4 shows an overhead view of the product collating system of FIG. 1,

FIG. 5 shows a front view of the drum mechanism and cam profiles of an interior drum in accordance with an embodiment of the present invention;

FIG. 6 shows an expanded view of a hub vacuum manifold, a vacuum distribution hub, and vacuum cups attached to a vacuum manifold in accordance with an embodiment of the present invention; and

FIG. 7 shows a flattened view of a configuration of the cam profiles of the interior drum in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a collating system that rotates, merges, and shingles pouches outputted from a pouch form/fill/seal machine to form compressed layers of shingled product to maximize the space in a carton or case, thereby obviating any need for pouches or any other suitable material from needing to be manually rotated, merged, and shingled by hand.

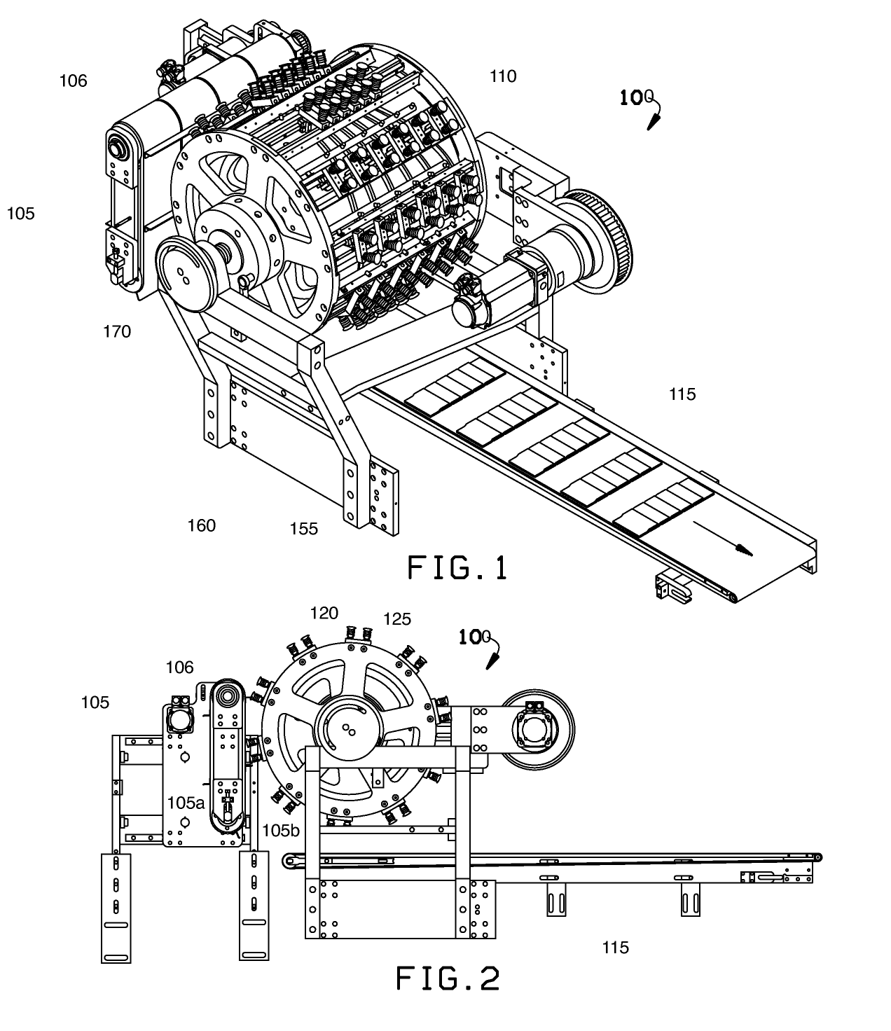

As shown in FIGS. 1 and 2, the collating system 100 may comprise a holding belt mechanism 105, a drum mechanism 110, and a conveyer belt 115 that work in tandem to collate products introduced into the collating system 100.

The holding belt mechanism 105 may be a conveyer belt having a cleated belt 106 that may continually loop around the body of the holding belt mechanism 105. The holding belt mechanism 105 may be situated in a vertical position, so that the cleated belt 106 on the holding belt mechanism 105 may move upwards at a first side 105a of the holding belt mechanism 105 and move downwards at a second side 105b of the holding belt mechanism 105.

The drum mechanism 110 may comprise an outer drum 120 and an inner drum 125, and may be situated near the second side 105b of the holding belt mechanism 105 where the cleated belt 106 on the holding belt mechanism 105 may move in a downward direction. The outer drum 120 in the drum mechanism 110 may rotate along a cylindrical axis so that the outer drum 120 may rotate in direction towards the holding belt mechanism 105 while the inner drum 125 may remain fixed. Thus, for example, the holding belt mechanism 105 may move in a clockwise direction while the rotating outer drum 120 moves in a counterclockwise direction. A vacuum distribution hub 155 and a hub vacuum manifold 160 for controlling vacuum within the drum mechanism 110 may also be axially disposed along the cylindrical axis of the drum mechanism 110, while a format change wheel 170 may be rotatable to modify the drum mechanism 110 depending on the format of the products being introduced into the collating system 100.

As shown in FIG. 3, the drum mechanism 110 and the holding belt mechanism 105 may be mounted on linear guides 165. The drum mechanism 110 may be cleared out from an operating position, as shown in FIG. 2, to a clear out position via the linear guides 165 which may separate the drum mechanism 110 from the holding belt mechanism 105. The clear out action may be triggered, such as by pressing a button, and, once the drum mechanism 110 is in a clear out position, such a button may be pressed to return the drum mechanism 110 to an operating position for it to continue to operate.

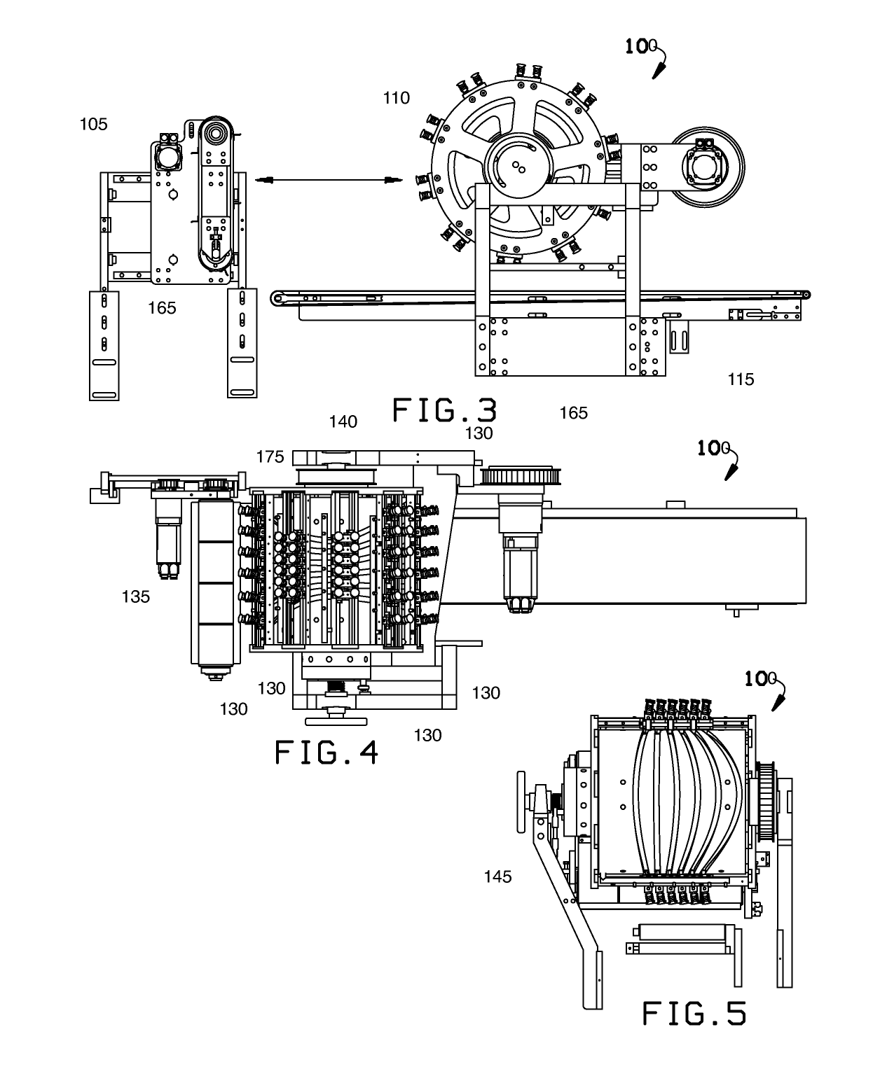

As shown in FIGS. 4 and 5, the drum mechanism 110 may be rotated via a driven pulley 175. The outer drum 120 on the drum mechanism 110 may comprise a plurality of pick head modules 130 that may each comprise a plurality of vacuum cups 135. In one exemplary embodiment, the outer drum 120 may comprise ten pick head modules 130 spaced along the circumference of the outer drum 120. The plurality of vacuum cups 135 within each pick head module 130 may further be divided into one or more linear blocks 140, where each linear block 140 may comprise a pair of vacuum cups 135. In one exemplary embodiment, a pick head module 130 may comprise six linear blocks 140, although a pick head module 130 may comprise from two to more than twenty-four linear blocks 140.

As the outer drum 120 rotates, the linear blocks 140 may ride along fixed cam profiles 145 on the circumference of the fixed inner drum 125, and may move according to the shape of the cam profiles 145, which may be milled into the circumference of the fixed inner drum 125. The number and shape of the cam profiles 145 milled into the fixed inner drum 125 may vary to accommodate the number of linear blocks 140 within each pick head module 130.

Products, such as pouches or any other products that may need to be collated, may be introduced vertically from a multi-lane pouch form, fill, and seal machine to the top of the gap between the second side 105b of the holding belt mechanism 105 and the drum mechanism 110. The gap between the holding belt mechanism 105 and the drum mechanism 110 may be small enough so that vacuum cups 135 on the outer drum 120 may be able to capture the products held on the cleated belt 106 of the holding belt mechanism 105.

As the products are introduced through the gap, they may be held onto by the cleated belt 106 of the holding belt mechanism 105 and may move down the second side 105b of the holding belt mechanism 105 according to the movement of the cleated belt 106. As the products move down the second side 105b of the holding belt mechanism 105, a pick head module 130 may be rotated towards the holding belt mechanism 105 according to the rotation of the outer drum 120. When the pick head module 130 is at a pick up location, vacuum may be applied to the vacuum cups 135 within the pick head module 130 closest to the products held by the holding belt mechanism 105 and may capture the products held by the holding belt mechanism 105.

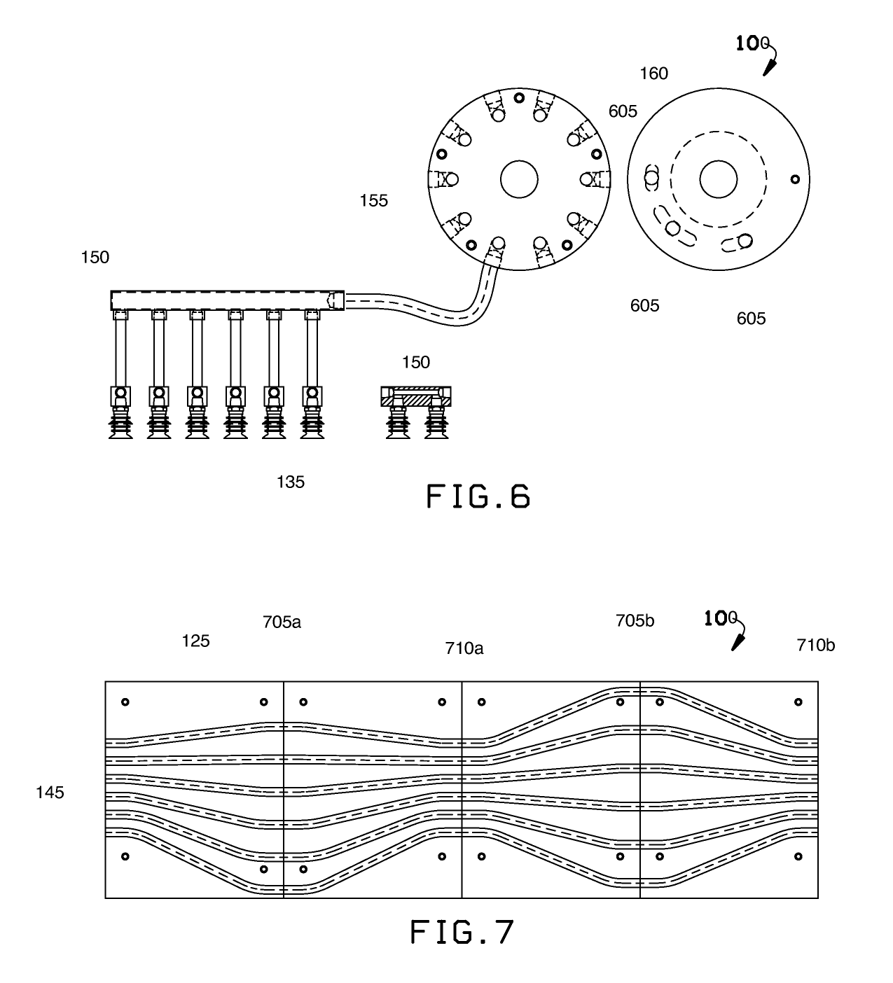

As shown in FIG. 6, vacuum may be applied to the vacuum cups 135 for capturing the products held by the holding belt mechanism 105 through a vacuum manifold 150. The vacuum manifold 150 may be provided for each linear block 140 of a pair of vacuum cups 135, and the vacuum manifold 150 may control vacuum distribution from a vacuum source to its corresponding pair of vacuum cups 135. The vacuum cups 135 may be connected to the vacuum manifold 150 and the vacuum manifold 150 may be connected to a rotating vacuum distribution hub 155. A hub vacuum manifold 160 may be in a fixed position and may contain valving 605 for vacuum from a vacuum source or air from an air source while the vacuum distribution hub 155 may supply and control the vacuum provided to the vacuum manifold 150. Both the vacuum distribution hub 155 and the hub vacuum manifold 160 may be situated axially along the shaft of the drum mechanism 110.

Once the pick head module 130 has captured the products from the holding belt mechanism 105, the pick head module 130 may continue to move according to the rotation of the outer drum 120 until the pick head module 130 is at a drop location situated close to the conveyer belt 115. When the pick head module 130 is at the drop location, the vacuum manifold for each linear block 140 within the pick head module 130 may release the vacuum to each pair of vacuum cups 135 within the linear blocks 140 of the pick head module 130, thereby causing the products captured by the pick head module 130 to be released from the pick head module 130 onto the conveyer belt 115.

As the pick head module 130 moves from the pick up location to the drop rotation, the vacuum cups 135 within the pick head module 130 may continue to move along the cam profiles 145. As shown in FIG. 7, the vacuum cups 135 within the pick head module 130 may be at a small format pick location 705a or a large format pick location 705b along the cam profiles 145 when the pick head module is at the pick up location, depending on the format of the products being picked up, and the pick head module 130 may move along the cam profiles 145 until the vacuum cups 135 within the pick head module 130 may be at a corresponding small format drop location 710a or a corresponding large format drop location 710b along the cam profiles 135 when the pick head module 130 reaches the drop location.

In accordance with an exemplary embodiment, the cam profiles 145 at the small format drop location 710a and the large format drop location 710b may be closer together than the cam profiles 145 at the small format pick location 705a and the large format pick location 705b, meaning that the vacuum cups 135 within the pick head module 130 may also move closer to one another as the vacuum cups 135 ride the cam profile 145 from the pick locations 705a and 705b to the drop locations 710a and 710b. Correspondingly, the products captured by the vacuum cups 135 may also move closer to each other as they move from the pick up location to the drop location according to the rotation of the outer drum 120, thereby merging, rotating, and shingling the products so that compressed layers of shingled products are released onto the conveyer belt 115 to be packed and shipped.

It should be understood, of course, that the foregoing relates to exemplary embodiments of the invention and that modifications may be made without departing from the spirit and scope of the invention as set forth in the following claims.

We claim:

1. A system for collating a plurality of products comprising:
a holding belt mechanism operable to hold onto products introduced vertically onto the holding conveyer belt;
a conveyer belt; and
a drum mechanism including:
a rotating outer drum,
a plurality of pick head modules on the rotating outer drum, and
a plurality of vacuum cups within each of the plurality of pick head modules, wherein the plurality of vacuum cups are operable to capture the products held onto by the holding conveyer belt and to release the products in a collated manner onto the conveyer belt.

2. The system of claim 1, wherein:
the holding conveyer belt comprises a cleated conveyer belt.

3. The system of claim 1, further comprising:
a vacuum manifold operable to introduce vacuum to at least a portion of the plurality of vacuum cups to capture the products from the holding conveyer belt and further operable to release the vacuum from the at least the portion of the plurality of vacuum cups to release the products from the vacuum cups and onto the conveyer belt.

4. The system of claim 1, wherein the drum mechanism further comprises:
a fixed inner drum including a cam profile, wherein the plurality of vacuum cups on the rotating outer drum are situated according to the cam profile.

5. The system of claim 1, wherein each of the pick head modules comprises a plurality of linear blocks, wherein at least one of the linear blocks comprises a pair of vacuum cups.

6. The system of claim 1 wherein a first pick head module on the rotating outer drum comprises a first plurality of linear blocks, and a second pick head module and a second pick head module on the rotating outer drum comprises a second plurality of linear blocks that is different in number than the first plurality of linear blocks.

7. The system of claim 1, wherein the holding conveyer belt rotates in a first direction and the rotating outer drum rotates in a second direction opposite the first direction.

8. A method for collating a plurality of products comprising:
receiving the plurality of products onto a holding belt mechanism;
capturing, by vacuum cups on a rotating outer drum, the plurality of products from the holding conveyer belt;
merging and shingling the plurality of products; and
releasing from the vacuum cups the merged and shingled plurality of products onto a conveyer belt.

9. The method of claim 8 wherein:
the capturing further comprises introducing vacuum to the vacuum cups; and
the releasing further comprises releasing the vacuum from the vacuum cups.

10. The method of claim 8, further comprising:
rotating the vacuum cups according to the rotating outer drum away from the holding conveyer belt and towards the conveyer belt.
